(19) United States
(12) Patent Application Publication
(10) Pub. No.: US 2004/0098326 A1
(43) Pub. Date: May 20, 2004

(54) Stored value currency conversion systems and methods

(75) Inventors: Kevin A. James, Waynesville, NC (US); David R. Baumgartner, Parker, CO (US); Keith A. Newbrough, Parker, CO (US); Peter A. Pridgeon, Plantation, FL (US); Ryan G. Teixeira, Coral Springs, FL (US); Danielle E. Cox, Parkland, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/286,006

(22) Filed: Nov. 1, 2002

(51) Int. Cl. G06F 17/60

(52) U.S. Cl. 705/36; 705/37

(57) ABSTRACT

A method for performing financial transactions in different currencies proceeds by entering an identifier of a presentation instrument into a point-of-sale device along with a redemption amount in a transaction currency that is different from the base currency that is associated with the presentation instrument. The identifier, the redemption amount and a transaction currency code are transmitted to a host computer system. In turn, the host computer system transmits back to the point-of-sale device a new balance in the base currency.

### BACKGROUND OF THE INVENTION

This invention relates generally to the field of currency conversion. More specifically, the invention relates to currency conversion involving transactions relating to stored value accounts.

Stored value accounts have gained widespread use in the United States, among other countries. Such stored value accounts are typically associated with a card having an account number, and are often referred to as “gift cards.” These cards can often be purchased at a retail location for a special amount, e.g., $20. After paying for the card, the account number is read from the card, such as by using a mag stripe reader. The account number is transmitted to a database where the associated account is credited for $20. Each time a purchase is made, the account is debited by the purchase amount.

One issue with such cards is how to handle situations where the cardholder wishes to make a purchase in a currency that is different from the originating currency where the card was purchased. For example, a cardholder may wish to use a card that was purchased in the United States in France. Previously, such transactions were generally not permissible because of the differing currencies. As such, the cardholder's request to use the card in making the purchase may be denied.

### BRIEF SUMMARY OF THE INVENTION

The invention provides systems and methods for converting currencies when performing transactions involving stored value accounts. According to one exemplary method, an identifier from a presentation instrument is entered into a point-of-sale device along with an activation amount. This information is then transmitted from the point-of-sale device to a host computer system along with a base currency code. The host computer system activates the account for the activation amount and associates that amount with the base currency. For example, an account may be activated for twenty U.S. dollars.

When ready to redeem part or all of the amount associated with the account, the identifier is again entered into a point-of-sale device along with a redemption amount. For example, a consumer may wish to purchase a movie for fifteen dollars. This information is transmitted to the host computer system along with a transaction currency, which is the local currency in which the transaction is being performed. The host computer system compares the base currency code that is associated with the account with the transaction currency code. If the base currency code is different from the transaction currency code, the host computer system uses currency conversion information to convert the transaction amount to the base currency.

The host computer system may also calculate and store a variety of other information relating to the transaction. Some or all of this information may also be transmitted back to the point-of-sale device. Such information may include, for example, the base currency, the previous balance in the base currency, the new balance in the base currency, the exchange rate used in the conversion, the transaction amount in the transaction currency, the new balance in the transaction currency, and the like. Some or all of this information may be displayed on a display screen of the point-of-sale device. Optionally, such information may also be printed on a receipt using a printer associated with the point-of-sale device.

In the event that a currency conversion is not needed, the host computer system may send back to the point-of-sale device the transaction amount in the base currency, the new balance in the base currency and the previous balance in the base currency. This information may conveniently be displayed by the point-of-sale device and/or printed on a receipt.

The base and transaction currency codes may be provided in a variety of ways. For example, the host computer system may receive information from the location of the point-of-sale device being used. The host computer system may then determine the transaction currency based on the location of the point-of-sale device. As another option, the point-of-sale device may be configured to ask for an input as to the base and/or transaction currency. This information may then be transmitted to the host computer system.

In another exemplary embodiment, the invention provides a currency conversion computer system that comprises an input interface, an output interface, and a processor that is operably connected to the input interface and the output interface. The system also includes a memory having at least one account identifier. With such a configuration, the input interface may receive a request to activate an account that is associated with the identifier, and to receive a base currency code identifying a base currency. The processor may then activate the account to associate the base currency.

The input interface may also receive a request to debit the account. Such a request may include a transaction currency code so that the processor may compare the transaction currency code to the base currency code. If the two codes are different, the account maybe debited using the base currency after performing a currency conversion.

The processor may also be configured to transmit to a point-of-sale device using the output interface a previous balance in the base currency, a new balance in the base currency and the exchange rate used to perform the currency conversion

### BRIEF DESCRIPTION OF THE DRAWINGS

FIG. 1 is a schematic diagram of a currency conversion system according to the invention.

FIG. 2 is a schematic diagram of one embodiment of a point-of-sale device that may be used in the system of FIG. 1.

FIG. 3 is one example of a screen display produced by the point-of-sale device of FIG. 2 to permit a currency code to be entered.

FIG. 4 illustrates another screen display that may be produced by the point-of-sale device of FIG. 2 illustrating transaction information that may be displayed following a redemption.

FIG. 5 is a flowchart illustrating one method for activating an account in a base currency and performing a redemption transaction in the base currency or in a local currency according to the invention.

### DESCRIPTION OF THE SPECIFIC EMBODIMENTS

The invention provides various systems and methods for converting currencies when performing various transactions. The systems and techniques of the invention may be used with a wide variety of transactions where currencies need to be converted. Such situations may arise, for example, when using presentation instruments that are associated with an account that is typically managed using a base currency, and where purchases or redemptions are handled in a transaction currency that is different from the base currency. For example, the company, bank, financial institution, or other organizational entity that manages the account may be located within the United States and therefore be based on U.S. dollars. However, the account owner may desire to make a purchase in another country, such as Mexico. When the request to purchase is received at the entity responsible for processing the account, the transaction details may be transmitted in Mexican pesos. The invention provides techniques for detecting the different currency and converting it to the base currency so that the transaction may be performed using a common currency. Information regarding the currency conversion may be transmitted back to the point-of-sale or redemption by a host computer system to provide both the merchant and the consumer with details on the currency conversion.

One particular non-limiting example of how such techniques may be used is with stored value accounts. Such accounts typically have an associated identifier that may conveniently be stored on a presentation instrument, such as a card. Such presentation instruments may initially be in an inactive state where no value is associated with the presentation instrument. To associate a value with the account, a consumer may purchase one of the cards for a certain amount, such as fifty dollars. Conveniently, this transaction may be processed at a merchant location. In such cases, the merchant collects a payment, using cash, credit card, debit card or any other acceptable form of payment, and enters this information into a point-of-sale device. The account identifier associated with the presentation instrument is also entered into the point-of-sale device. For example, the identifier may be stored on a magnetic stripe, on a bar code label, or the like. Examples of such point-of-sale devices that may be used to capture and/or transmit such information to a host computer system are described in copending U.S. application Ser. No. 10/116,619, filed Apr. 3, 2002, the complete disclosure which is herein incorporated by reference. However, it will be appreciated that the invention is not intended to be limited to a specific type of processing/reading device. For example, other ways of transmitting information include by telephone (such as by using an IVR system), by contacting a customer service representative or the like.

Such information is transmitted to the host computer system which has a record of the account identifier. Such information may be transmitted across a variety of networks including telephone networks, credit card networks, wide area networks, the Internet, wireless networks, and the like. Further, depending on the type of processing device used to transmit the information, such devices may also be coupled to a financial network, such as a credit card or ATM network, or may have a direct connection to the host computer system. If connected to a financial network, the host computer system may be configured to determine that the transaction is related to a stored value account rather than a traditional credit or debit card and may process the information appropriately.

When such information is received at the host computer system, the value that was paid by the consumer is associated with the account identifier. In so doing, the account is activated so that the consumer may then use the presentation instrument for making a subsequent purchase.

In addition to the activation amount and the associated identifier, a base currency code is transmitted to the host computer system. In this way, the account will be associated with a base currency. For example, a U.S. consumer will typically want their account processed in U.S. dollars. As such, a base currency code relating to the United States may be transmitted to the host computer system at the time the presentation instrument is purchased. The base currency code may be transmitted in a variety of ways. For example, the point-of-sale device may request that the base currency code be entered and transmitted. Alternatively, the host computer system may determine the location of the point-of-sale device and simply assign a base currency based on the location of the originating point-of-sale device. In some cases, the base currency code could even be read off the presentation instrument by the point-of-sale device. As another option, the point of sale device may store the currency code.

To redeem part or all of the value associated with the presentation instrument, the consumer simply needs to provide the account identifier at the time of redemption. For example, if a U.S. consumer desired to purchase a video in Canada, the consumer may simply provide the presentation instrument to the clerk at the time of check out. The identifier may then be read from the presentation instrument using a point-of-sale device and transmitted back to the host computer system. Along with this information, a local or transaction currency code may also be transmitted. This may be entered and transmitted using any of the techniques previously described in connection with the base currency code. The host computer system is configured to compare the base currency code with the transaction currency code to determine whether they are the same or different. If they are the same, the transaction may be carried out all in the base currency. As such, the account may be debited by the transaction amount and information confirming the transaction transmitted back to the point-of-sale device.

In cases where the two codes are different, the host computer system may access currency conversion data to obtain an exchange rate. The transaction amount may then be converted to the base currency so that the account may be debited by the transaction amount in the base currency. Various information regarding the transaction may then be transmitted back to the point-of-sale device. For example, such information may include the base currencies, the exchange rate, the amount debited in the base currency, the new balance in the base currency, the transaction amount in the transaction currency, the new balance in the transaction currency, and the like. This information may be displayed by the point-of-sale device and may optionally be printed to provide a paper receipt.

The currency conversion techniques may be used with a wide variety of financial transactions. For example, currencies may be converted at the time an account is activated, when making a redemption, when reloading value to an account, and when making a balance inquiry. Another example is during pre-authorization when the balance of an account is locked for a certain amount of time, such as when purchasing gasoline at a gas station. Voids associates with such processes may also involve currency conversions.

The presentation instruments of the invention may be constructed of a wide variety of materials that are capable of storing an identifier that uniquely identifies the associated account. For example, the material may comprise a card (that in turn may be constructed of plastic, cardstock, paper, or the like), a computer disk, (such as a CD, DVD or the like), or other tangible media. Further, the identifier may be stored in a variety of formats, such as in print, on magnetic media, in a bar code format, in a computer processor (also known as a smart chip) or the like. Appropriate readers may be employed at the point-of-sale to read such formats and then transmit them to the host computer system for processing.

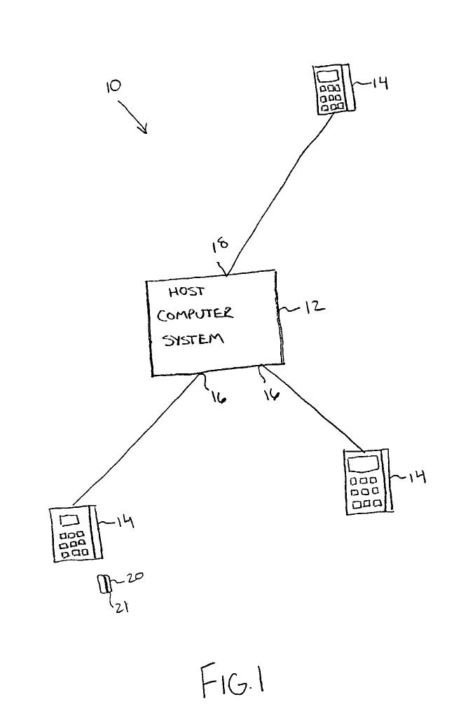

Referring now to FIG. 1, one embodiment of a currency conversion system 10 will be described. Central to system 10 is a host computer system 12 that may communicate with a variety of point-of-sale devices 14 over any type of network or other communication system as previously described. Host system 12 may include one or more processors, and one or more types of memory, including associated databases, to process and store appropriate information. Host computer system 12 may also include input interfaces 16 and output interfaces 18 to permit various types of data to be input and to output from host computer system 12 as is known in the art.

A wide variety of information may be stored in computer system 12. Such information may include, for example, account identifiers that uniquely identify each account. Other information that may be associated with each account identifier includes a base currency code, an opening balance, an existing balance, transaction amounts associated with each transaction, including debits to the account, redemption locations, redemption times, redemption amounts, local or transactional currencies used for various transactions, exchange rates used in converting currencies, and the like. Host computer system 18 may also include updated currency exchange information, such as exchange rates that may be regularly updated from a variety of services, such as Bloomberg. Exchange rate information may also be obtained from Internet downloads, internal systems, and the like. The exchange rate information may be input into host system 12 using input interface 16 and may be stored in an appropriate database.

System 10 may also utilize a presentation instrument 20 that may be used to store an account identifier. As shown, presentation instrument 20 is in the form of a card having a mag stripe 21 storing the account identifier. However, as previously described, it will be appreciated that a variety of other presentation instruments may be used.

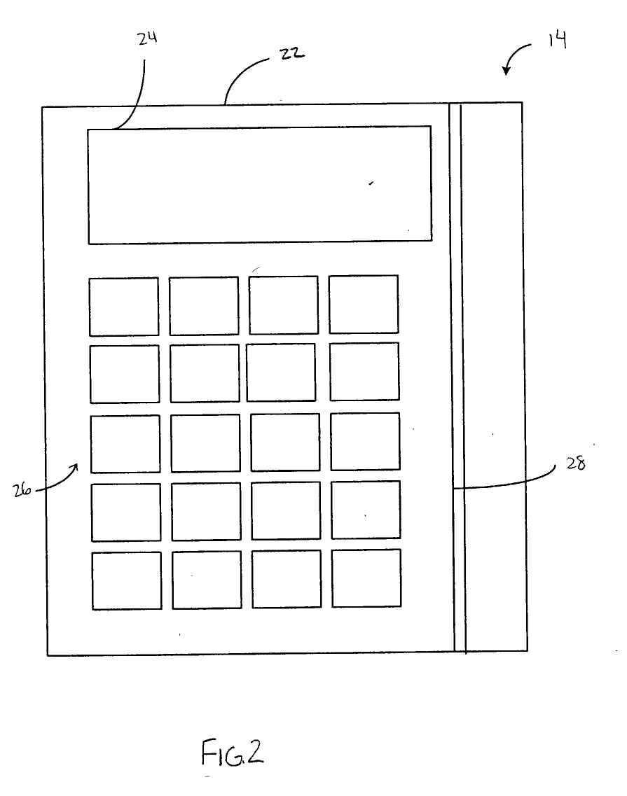

Referring now to FIG. 2, point-of-sale device 14 will be described in greater detail. In so doing, it will be appreciated that the invention is not intended to be limited for use with only a specific type of point-of-sale device. Indeed, any type of processing or computing device that may transmit and receive data over a network may be used.

Point-of-sale device 14 comprises a housing 22 having a display screen 24 and input devices 26. Conveniently, input device 26 may comprise keys or buttons that may be depressed to enter information into a point-of-sale device 14. Input devices 26 may each be associated with one or more letters or other alpha numeric characters, or may operate as function keys.

Point-of-sale device 14 also includes a reader 28 that may be used to read information from mag stripe 21 of presentation instrument 20. Alternatively, reader 28 may be configured to read a variety of other formats such as bar code labels, smart chips, and the like in a manner similar to that previously described.

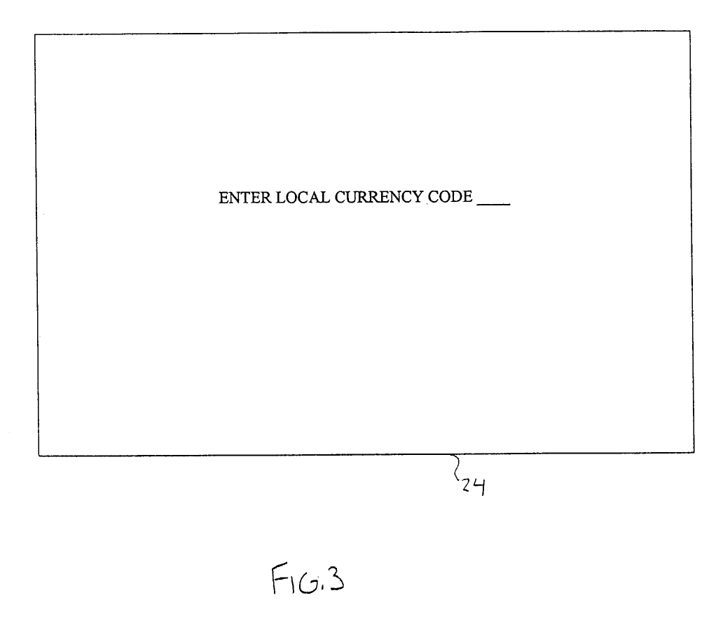

FIG. 3 illustrates display screen 24 that may be generated when requesting information be entered as to a currency code. This could be the local or transaction currency code, or the base currency code. For example, the base currency code for the United States may be 840 and may be entered using input devices 26. The local currency code for Canada may be 124 and may be entered in a similar manner. Point-of-sale device 14 may be configured to automatically request the currency code be entered at the time the presentation instrument is purchased or when performing a redemption transaction. In some embodiments, the currency codes may comprise characters such as alpha characters, numeric characters, alphanumerical characters, or the like.

As an alternative, point-of-sale device 14 may be configured to store a currency code that is automatically transmitted to the host computer system each time a transaction is performed. In this way, host computer system 12 may include a lookup table that simply associates a currency with the currency code received from the point-of-sale device 14.

As another example, presentation instrument 20 may include the base currency code so that when the presentation instrument is activated, the code may simply be read from the presentation instrument. In some cases, the code may even be part of the account identifier. For example, the account identifier may be 16 digits, and the first two digits may comprise the-base currency code.

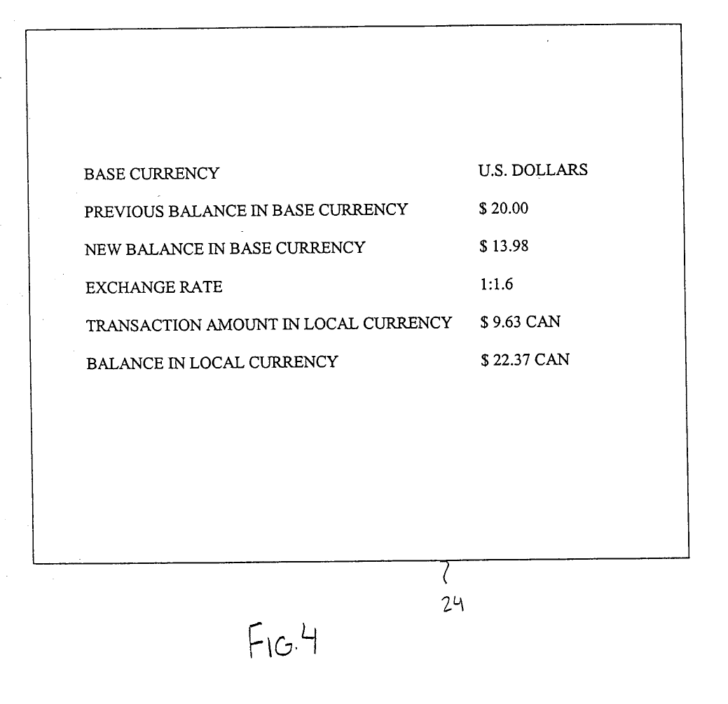

FIG. 4 illustrates display screen 24 following the purchase of an item in a local currency that is different from the base currency. At the time of purchase, point-of-sale device 14 may transmit to host computer system 12 the account identifier, a local currency code, and the amount of the transaction in the local currency. The host computer system is able to determine that the transaction is in a currency that is different from the base currency and performs a lookup to determine the proper exchange rate. In the example illustrated in FIG. 4, the transaction amount in the local currency is $9.63 in Canadian dollars. The exchange rate is 1.6 Canadian dollars for every one U.S. dollar. Hence, after performing the conversion, the transaction amount in the base currency is $6.02. If the originating balance in the base currency were $20.00, the new balance is the base currency would then be $13.98. Further, host computer system 12 may be configured to determine the balance in the local currency, which in this case would be $22.37 Canadian. All of this information may be stored in host computer system 12, and some or all of this information may be transmitted back to point-of-sale device 14 for display on display screen 14 as illustrated in FIG. 4. Further, point-of-sale device 14 may include an associated printer that may print any or all of this information on a receipt that is provided to the consumer.

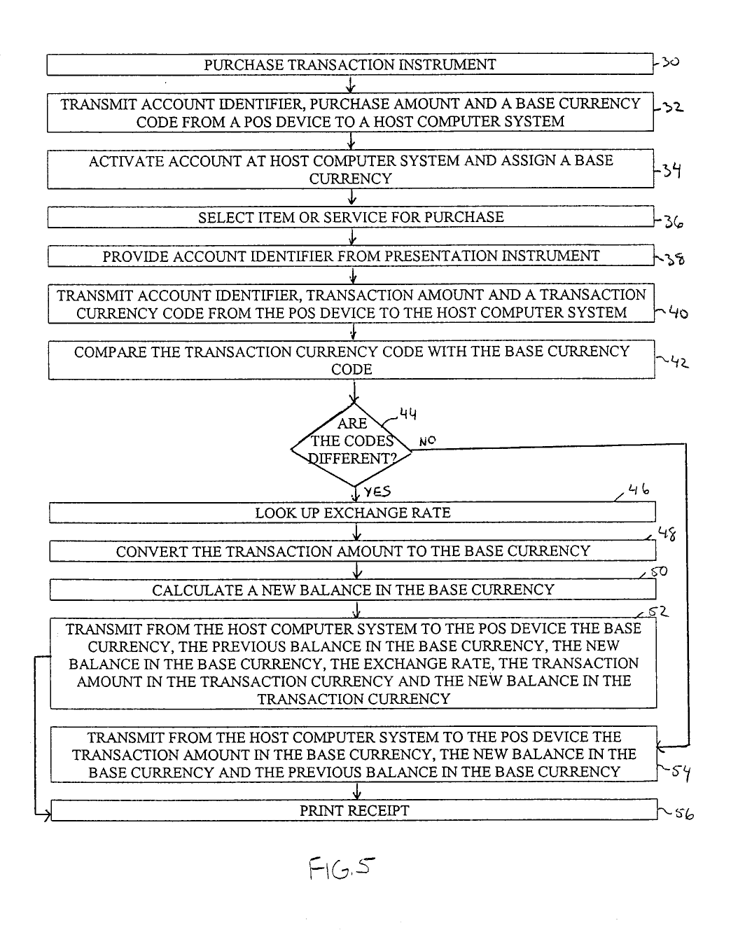

Referring now to FIG. 5, one method for activating an account in a base currency and then forming one or more redemption transactions in the same or a different currency will be described. Initially, a transaction instrument is purchase as illustrated in step 32. Conveniently, such transaction instruments may be provided for sale at various retail locations. As such, the transaction instrument may be taken to the check out counter, and the consumer may indicate an activation amount.

The consumer provides the check out clerk with the appropriate payment which may be in the form of cash, check, credit card, debit card or the like. The account identifier from the transaction instrument is then transmitted from a point-of-sale device to a host computer system along with the purchase amount and a base currency code. This is illustrated in step 32. Upon receipt of such information, the host computer system activates the account for the purchased amount and assigns a base currency to the account.

The process proceeds to step 36 when a user is ready to redeem some or all of the amount associated with the account. Such a process typically proceeds by selecting an item or service for purchase. The account identifier is then provided from the presentation instrument as illustrated in step 38. Conveniently, the point-of-sale device or other associated equipment may be used to read the account identifier from the presentation instrument. As shown in step 40, the account identifier, the transaction amount and a transaction currency code are transmitted from point-of-sale device to the host computer system. The host computer system compares the transaction currency code with the base currency code as shown in step 42. An inquiry is then made as to whether or not the codes are different as shown in step 44.

If the codes are different, it is an indication that the transaction currency is different from the base currency. As such, an exchange rate lookup is performed at the host computer system as illustrated in step 46. The transaction amount is then converted to the base currency using the obtained exchange rate as illustrated in step 48. A new balance is then calculated in the base currency by simply subtracting the transaction amount in the base currency from the previous account balance in the base currency as shown in step 50. This information may be stored at the host computer system along with the information received from the point-of-sale device resulting from the purchase.

As shown in step 52, the host computer system may transmit back to the point-of-sale device any of the following information: the base currency, the previous balance in the base currency, the new balance in the base currency, the exchange rate, the transaction in the transaction currency, the new balance in the transaction currency, and the like. This information may be displayed and/or printed at the point-of-sale device.

If the base currency code and the transaction currency code are the same, the process proceeds to step 54 where the account is debited by the transaction amount. The host computer system may then transmit to the point-of-sale device information such as the transaction amount in the base currency, the new balance in the base currency, the previous balance in the base currency, and the like. This information may be displayed at the point-of-sale device and a receipt may be printed as illustrated in step 56.

In some cases, the purchaser of the presentation instrument may desire to have the account activated in a currency that is different from the currency being used to purchase the presentation instrument. In such cases, the base currency code that is entered may be for the desired base currency, even if different from the purchasing currency. For example, a U.S. consumer may purchase a card in California using U.S. dollars but designate the base currency code as being in Canadian dollars. Hence, the presentation instrument may be used in Canada without needing to perform a currency conversion when purchases are made in Canada.

Conversely, a recipient of the card may decide to change the base currency at any time. For example, a Canadian consumer may have received a presentation instrument as a gift from a U.S. consumer that purchased the presentation instrument in the U.S. and designated U.S. base currency. When making a purchase in Canada, the point-of-sale device may be configured to ask the consumer whether the base currency should be converted to Canadian dollars. In such cases, the currency may be converted and the account debited by the purchase amount in the transaction currency. The exchange rate information may be used to convert the previous account balance to Canadian dollars.

The invention has now been described in detail for purposes of clarity and understanding. However, it will be appreciated that certain changes and modifications may be practiced within the scope of the appended claims.

What is claimed is:

1. A method for associating a currency with a financial transaction, the method comprising:
receiving at a host computer system a request to activate an account that is associated with a presentation instrument;
receiving at the host computer system a base currency code identifying a base currency that is to be associated with the account;
activating the account in the host computer system and associating the base currency with the account.

2. A method as in claim 1, wherein the request to activate the account includes an identifier from the presentation instrument and a purchase amount.

3. A method as in claim 1, wherein the account is activated by flagging the account in the host computer system as active.

4. A method as in claim 1, further comprising receiving at the host computer system a request to debit the account for a certain amount in a transaction currency, wherein the request to debit includes a transaction currency code identifying the transaction currency; comparing the base currency code with the transaction currency code; and debiting the account using the base currency if the base currency code is different than the transaction currency code.

5. A method as in claim 4, further comprising receiving at the host computer system currency conversion information, and converting the certain amount to the base currency using the currency information if the transaction currency code is different than the base currency code.

6. A method as in claim 4, further comprising transmitting from the host computer system to a transaction computer system information indicating a new balance amount in the base currency.

7. A method as in claim 1, wherein the base currency code is received from a point of sale device.

8. A method as in claim 1, wherein the transaction currency code is received from a point of sale device.

9. A method for associating a currency with a financial transaction, the method comprising:
entering an identifier from a presentation instrument into a point of sale device along with an activation amount;
transmitting from the point of sale device to a host computer system the identifier, the activation amount and a base currency code;
receiving at the point of sale device from the host computer system information indicating that the account has been activated.

10. A method as in claim 9, wherein the base currency code is stored by the point of sale device and is automatically transmitted to the host computer system.

11. A method as in claim 9, further comprising entering the base currency into the point of sale device.

12. A method for performing financial transactions in different currencies, the method comprising:
entering an identifier of a presentation instrument into a point of sale device along with a redemption amount in a transaction currency that is different from a base currency that is associated with the presentation instrument;
transmitting to a host computer system the identifier, the redemption amount and a transaction currency code;
receiving at the point of sale device from the host computer system a new balance amount in the base currency.

13. A method as in claim 12, further comprising displaying the balance amount in the base currency on the point of sale device or printing a receipt using the point of sale device.

14. A method as in claim 12, further comprising reading the identifier from the presentation instrument using the point of sale device, and wherein the transaction currency code is transmitted from a memory in the point of sale device.

15. A method as in claim 12, further comprising entering the transaction currency code into the point of sale device.

16. A method as in claim 12, further comprising receiving at the point of sale device from the host computer system a previous balance amount in the base currency, an exchange rate, and the transaction amount in the transaction currency.

17. A currency conversion computer system comprising:
an input interface;
an output interface;
a processor operably connected to the input interface and the output interface; and
a memory having at least one account identifier;
wherein the input interface is configured to receive a request to activate an account that is associated with the identifier, and to receive a base currency code identifying a base currency, wherein the processor is configured to activate the account and to associate the account with the base currency.

18. A system as in claim 17, wherein the input interface is further configured to receive a request to debit the account, wherein the request includes a debit amount and a transaction currency code, and wherein the processor is configured to compare the transaction currency code to the base currency code, and to debit the account using the base currency if the transaction currency code is different than the base currency code.

19. A system as in claim 18, wherein the memory includes currency conversion information, and wherein the processor is configured to convert the debit amount to the base currency using the conversion information.

20. A system as in claim 19, wherein the processor is further configured to transmit the debit amount in the transaction currency to a point of sale device using the output interface.

21. A system as in claim 19, wherein the processor is further configured to transmit to a point of sale device using the output interface a previous balance in the base currency, a new balance in the base currency and an exchange rate.
